(19) United States
(12) Patent Application Publication
(10) Pub. No.: US 2008/0031184 A1
(43) Pub. Date: Feb. 7, 2008

(54) Bluetooth-based communication system and method

(75) Inventor: Kem-Suk Seo, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/716,242

(22) Filed: Mar. 9, 2007

(30) Foreign Application Priority Data
Aug. 7, 2006 (KR) 2006-0074204

(51) Int. Cl. H04Q 7/00

(52) U.S. Cl. 370/328

(57) ABSTRACT

A Bluetooth®-based communication system and method are disclosed. A communication method for a short range wireless communication system includes generating, at a first terminal, a list of second terminals supporting a chat function; establishing at least one asynchronous connectionless link between the first terminal and at least one second terminal; and exchanging chat packets through the asynchronous connectionless link between the first and second terminals. The communication system and method for portable terminals according to the present invention enable the portable terminals to exchange messages in the unlicensed 2.4 GHz Industrial Scientific Medical (ISM) frequency band without engagement of a fixed base station, whereby it is possible for the portable terminals to communicate outside a main communication system coverage.

### PRIORITY

This application claims priority under 35 U.S.C. § 119 to an application entitled “BLUETOOTH®-BASED COMMUNICATION SYSTEM AND METHOD” filed in the Korean Intellectual Property Office on Aug. 7, 2006 and assigned Serial No. 2006-0074204, the contents of which are incorporated herein by reference.

### BACKGROUND OF THE INVENTION

1. Field of the Invention

The present invention relates generally to a Bluetooth®-based communication system and, in particular, to a Bluetooth®-based communication system and method.

2. Description of the Related Art

Handheld devices are rapidly becoming an integral part of daily life, and many people already carry a cell phone, palmtop, and laptop computer with them. In most cases, these devices do not have compatible data communication interfaces, or, if they do, the interface requires cumbersome cable connections and configuration procedures. An obvious solution is to dispose of the cables and use short-range wireless links to facilitate on-demand connectivity among devices. An ideal solution would also be inexpensive, enabling of compelling application, and universally adopted by device vendors.

Bluetooth® (Bluetooth) is an open specification for a wireless system that provides the network infrastructure to enable short range wireless communication of data and voice. It includes a hardware component and a software component. The specification also describes usage models and user profiles for these models.

Bluetooth facilitates the concept of “hidden computing” by providing radio devices “unconscious” connectivity without a user's proactive intervention. It provides a bearer service for wireless applications.

Bluetooth radios operate in the unlicensed Industrial Scientific Medical (ISM) band at 2.4 Gigahertz using 79 channels between 2.402 GHz to 2.480 GHz (23 channels in some countries). The range for Bluetooth communication is up to 10 meters with a power consumption of 0 dBm (1 mW). This distance can be increased to 100 meters by amplifying the power to 20 dBm. The Bluetooth radio system is optimized for mobility.

Bluetooth supports two kinds of links: Asynchronous ConnectionLess (ACL) links for data transmission and Synchronous Connection Oriented (SCO) links for audio/voice transmission. The gross Bluetooth data rate is 1 Mbps while the maximum effective rate on an asymmetric ACL link is 721 Kbps in one direction and 57.6 Kbps in the opposite direction. A symmetric ACL link allows for data rates of 432.6 Kbps. Bluetooth also supports up to three 64 Kbps SCO channels per device. These channels are guaranteed bandwidth for transmission.

Since Bluetooth operates in the unlicensed Industrial Scientific Medical (ISM) band that is also used by other devices such as Institute of Electrical and Electronics Engineers (IEEE) 802.11 networks, baby monitors, garage door openers, microwave ovens etc, there is a possibility of interference. Bluetooth uses Frequency Hop Spread Spectrum (FHSS) to avoid interference. A Bluetooth channel is divided into time slots, each measuring 625 microseconds in length. The devices hop through these timeslots at 1600 hops per second.

Bluetooth communication occurs between a master device and a slave device. Bluetooth devices are symmetric in that the same device can operate as the master and alternatively as the slave. Each device has a fixed 48 Bit unique Device ADDRess (BD_ADDR). At least two devices together form ad-hoc networks called piconets. All units within a piconet share the same channel. Each piconet has at least one master device and one slave devices. There can be at most seven active slave devices at a time within a piconet. Thus, each active device within a piconet is identifiable by a 3 Bit active device address. Inactive slave devices in unconnected modes can continue to reside within the piconet.

A master device is the only device that may initiate a Bluetooth communication link. However, once such a link is established, the slave device can request a master/slave switch to become the master. Slave devices are not allowed to talk to each other directly. All communication occurs between the slave and the master. Slave devices within a piconet must also synchronize their internal clocks and frequency hops with that of the master. Each piconet uses a different frequency hopping sequence. Wireless devices use Time Division Multiplexing (TDM). A master device in a piconet transmits on even numbered slots and the slave devices can transmit on odd numbered slots.

Multiple piconets with overlapping coverage areas form a scatternet. Each piconet can have only one master, but slave can participate in different piconets on a time-division multiplex basis. A device can be a master in one piconet and a slave in another or a slave in more than one piconet.

The Bluetooth protocol stack can be divided into four layers according to their purpose as shown in Table 1 below.

TABLE 1

| Protocol Layer | Protocols in The Stack |
|---|---|
| Bluetooth Core Protocols | Baseband, LMP, L2CAP, SDP |
| Cable Replacement Protocol | RFCOMM |
| Telephony Control Protocols | TSC Binary, AT-commands |
| Adopted Protocols | PPP, UDP/TCP/IP, OBEX, WAP, |
| | vCard, vCal, IrMC, WAE |

FIG. 1 is a view illustrating a structure of a Bluetooth protocol stack. As shown in FIG. 1, in some ways the Bluetooth protocol stack differs from the classical seven-layer networking model. These differences are primarily to support ad hoc connectivity among participating nodes, while conserving power and accommodating devices that lack resources to support all layers of the classical networking stack.

The Radio Frequency (RF) 101 is the lowest layer. Its interface specification defines the characteristics of the radio front end, frequency bands, channel arrangements, permissible transmit power levels, and receiver sensitivity level. The next layer is the baseband 103, which performs Bluetooth's PHYsical (PHY) and Media Access Control (MAC) processing. This includes tasks such as device discovery, link formation, and synchronous and asynchronous communication with peers. Bluetooth peers must exchange several control messages for the purpose of configuring and managing the baseband connections. These message definitions are part of the Link Manager Protocol (LMP). The functional entity responsible for carrying out the processing associated with LMP is called the link manager 105. Bluetooth is unique in offering the front-end RF processing integrated with the baseband module. On-chip integration lowers the cost of the network interface, and the small size makes it easy to embed Bluetooth chips in devices such as cell phones and PDAs. A Bluetooth chip can be connected to its host processor using Universal Serial Bus (USB), Universal Asynchronous Receiver and Transmitters (UART), or PC-card interfaces.

The Host Controller Interface (HCI) specification defines a standard interface-independent method of communicating with the Bluetooth chip. The software stack on the host processor communicates with the Bluetooth hardware using HCI commands. Since no hardware-specific knowledge is needed, the Bluetooth stack software can easily be ported from one Bluetooth chip to another. The HCI layer 107 is part of the Bluetooth stack, but does not constitute a peer-to-peer communication layer since the HCI command and response messages do not flow over the air link.

The Logical Link Control and Adaptation Protocol (L2CAP) 109 specification can be viewed as Bluetooth's link layer. Usually, L2CAP 109 and layers above it are implemented in software. L2CAP 109 delivers packets received from higher layers to the other end of the link. Bluetooth devices can establish an L2CAP connection as soon as they are in range of each other. A slave device then needs to discover the services provided by the master device.

The Service Discovery Protocol (SDP) 111 defines the means by which the slave device can discover services as well as their attributes. The SDP design has been optimized for Bluetooth. It defines only the discovery mechanisms; the methods for accessing those services are outside its scope.

The RFCOMM specification defines a method of emulating the RS-232 cable connection on top of the Bluetooth air link. RFCOMM 115 supports legacy applications that use the COM port to communicate with the peer host. For example, Point-to-Point Protocol (PPP) expects a serial line interface from the lower layer. Since PPP provides a packet-oriented interface to the higher layers, all packet-based network and transport protocols, including Transmission Control Protocol/Internet Protocol (TCP/IP), can be supported on top of PPP. More efficient methods of running IP over Bluetooth are currently under development.

The Telephony Control Specification (TCS) Binary 117 defines the call control signaling for the establishment of speech and data calls between Bluetooth devices. In addition, it defines mobility management procedures for handling groups of Bluetooth TCS devices.

Object Exchange (OBEX or, IrOBEX) 119 is a session protocol developed by the Infrared Data Association (IrDA) to exchange objects in a simple and spontaneous manner. OBEX, which provides the same basic functionality as Hyper Text Transfer Protocol (HTTP), but in a much lighter fashion, uses a slave-master model and is independent of the transport mechanism and transport Application Programming Interface (API), provided it realizes a reliable transport base. Along with the protocol itself, which provides the “grammar” for OBEX conversations between devices, OBEX also provides a model for representing objects and operations. In addition, the OBEX protocol defines a folder-listing object, which is used to browse the contents of folders on remote devices. In the first phase, RFCOMM is used as sole transport layer for OBEX. Future implementations are likely to support also TCP/IP as a transport.

As mentioned above, Bluetooth supports ACL links for data transmission and SCO links for audio/voice transmission.

Recently, mobile phones equipped with a Bluetooth module have emerged onto the market. Typically, such a built-in Bluetooth module is utilized for establishing a connection between the mobile phone and a hands-free device or a stereo headset device for transmitting an in-band ring-tone or music sound to the device. The in-band ring-tone signal is generated when the mobile phone receives a phone call. In this case, the device sometimes produces a ring-tone sound as represented by the in-band ring-tone signal. Sometimes, the built-in Bluetooth module of the mobile phone is used for sharing files with other Bluetooth-enable mobile phones or devices.

More recently, a mobile communication technique in which a wireless direct device-to-device link is implemented in accordance with the Bluetooth intercom profile has been provided.

However, the Bluetooth intercom profile does not consider a multi-user communication to allow several users to participate in a chat.

In addition, although the Bluetooth intercom profile specifies an SCO link for a direct device-to-device link, the service quality of the SCO link is not guaranteed, especially when more than two devices are connected to a master device, because of the limitation in data transmission rate of the SCO link.

### SUMMARY OF THE INVENTION

The present invention has been made in an effort to at least solve the above-mentioned problems, and an object of the present invention is to provide a communication system and method in which portable terminals each support a short range device-to-device communication.

Another object of the present invention is to provide a communication system and method that enable portable terminals to participate in a chat environment with at least one other portable terminal over respective asynchronous connectionless links and simultaneously to communicate with another portable terminal over a synchronous connection-oriented link.

It is another object of the present invention to provide a communication system and method that enable a portable terminal to participate in a chat with at least one other portable terminal over respective device-to-device Asynchronous Connectionless links to communicate with one other portable terminal over a device-to-device Synchronous Connection-Oriented link and/or to communicate with another portable terminal over a fixed station-engaged communication link.

In accordance with an aspect of the present invention, there is provided a communication method for a short range wireless communication system including at least two portable terminals directly connected to each other. The communication method includes generating, at a first terminal, a list of second terminals supporting a chat function; establishing at least one asynchronous connectionless link between the first terminal and at least a second terminal; and exchanging chat packets through the asynchronous connectionless link between the first and second terminals.

Preferably, exchanging chat packets includes determining, at the first terminal, whether the chat packet to be transmitted is a unicast chat packet before transmitting the chat packet from the first terminal to the second terminal; checking a link identifier of the asynchronous connectionless link if the chat packet is a unicast chat packet; transmitting the chat packet through the asynchronous connectionless link having the link identifier; and transmitting the chat packet through all asynchronous connectionless links if the chat packet is not a unicast chat packet.

Preferably, exchanging chat packets further includes determining, at the first terminal, whether a chat packet received from the second terminal is a unicast chat packet; and transmitting the chat packet through all asynchronous connectionless links except for the link through which the chat packet is received if the chat packet is not a unicast chat packet.

Preferably, the communication method further includes establishing a synchronous connection oriented link between the first terminal and a selected second terminal.

Preferably, the communication method further includes exchanging voice packets through the synchronous connection oriented link between the first and the selected second terminal.

In accordance with another aspect of the present invention, there is provided a communication method for a Bluetooth-based piconet including a master terminal and at least one slave terminal. The communication method includes discovering, at the master terminal, slave terminals; checking the slave terminals enabling a chat function among the discovered slave terminals; generating a list of slave terminals enabling a chat function; establishing at least one asynchronous connectionless link between the master terminal and at least one chat function-enabled slave terminal; and exchanging chat packets through the asynchronous connectionless link between the master and the chat function-enabled slave terminals.

Preferably, discovering slave terminals includes transmitting an IDentity (ID) packet; receiving Frequency Hopping Synchronization (FHS) packets from the slave terminals in response to the ID packet; and synchronizing a frequency hopping pattern on the basis of the FHS packet.

Preferably, exchanging chat packets includes determining, at the master terminal, whether the chat packet to be transmitted is a unicast chat packet before the master terminal transmits the chat packet; checking a link identifier of the asynchronous connectionless link if the chat packet is a unicast chat packet; transmitting the chat packet through the asynchronous connectionless link having the link identifier; and transmitting the chat packet through all asynchronous connectionless links if the chat packet is not a unicast chat packet.

Preferably, exchanging chat packets further includes determining, at the master terminal, whether a chat packet received from the slave terminal is a unicast chat packet; and transmitting the chat packet through all asynchronous connectionless links except for the link through which the chat packet is received if the chat packet is not a unicast chat packet.

Preferably, the communication method further includes establishing a synchronous connection oriented link between the master terminal and another slave terminal.

In accordance with another aspect of the present invention, there is provided a communication method for a wireless communication system including at least one fixed station serving a plurality of mobile terminals each having a fixed station-engaged communication interface and a terminal-to-terminal communication interface. The communication method includes establishing at least one terminal-to-terminal asynchronous connectionless link between a first mobile terminal and at least one second mobile terminal; establishing a terminal-to-terminal synchronous connection oriented link between the first mobile terminal and a selected second mobile terminal; and establishing a fixed station-engaged communication link between the first mobile terminal and yet another communication terminal.

Preferably, the communication method further includes exchanging chat packets through the asynchronous connectionless link between the first mobile terminal and the second mobile terminal in a push-to-talk manner. Preferably, the chat packet is a voice packet.

### BRIEF DESCRIPTION OF THE DRAWINGS

The above and other objects, features and advantages of the present invention will be more apparent from the following detailed description in conjunction with the accompanying drawings, in which:

FIG. 1 is a view illustrating a structure of a Bluetooth protocol stack;

FIG. 2 is a schematic view illustrating an example of a piconet according to the present invention

FIG. 3 is a schematic view illustrating a Bluetooth-enabled terminal according to the present invention;

FIG. 4 is a message flow diagram illustrating a discovery procedure for a communication system according to the present invention;

FIG. 5 is a message flow diagram illustrating a connection creation procedure for a communication system according to the present invention;

FIG. 6 is a frame format illustrating an HCI ACL Data Packet, which is used to exchange data between a Bluetooth host and the Bluetooth module;

FIG. 7 is a message flow diagram illustrating a chatting procedure for a communication system according to the present invention; and

FIG. 8 is a flowchart illustrating a chatting method over Bluetooth according to the present invention.

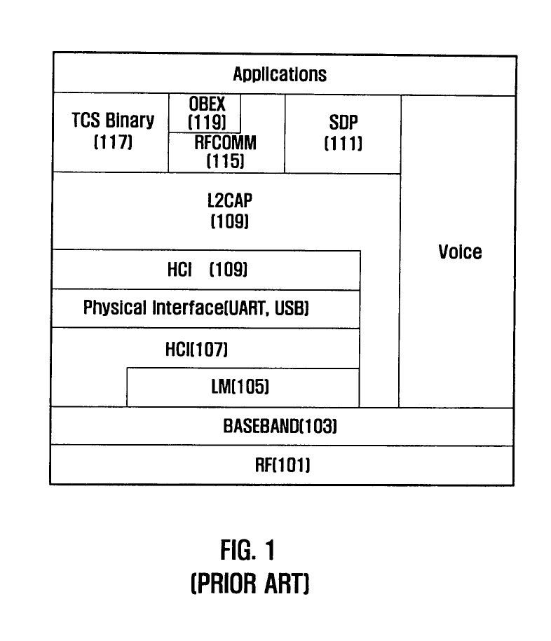

### DETAILED DESCRIPTION OF PREFERRED EMBODIMENTS

Preferred embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

While the present invention may be embodied in many different forms, specific embodiments thereof are shown in drawings and described herein in detail, with the understanding that the present disclosure is to be considered as an exemplification of the principles of the invention and is not intended to limit the invention to the specific embodiments illustrated.

The following description of the present invention is given for a piconet comprising a plurality of Bluetooth-enabled terminals as an example, but the piconet can include other communication devices supporting one of a Bluetooth interface and other short range communication interfaces.

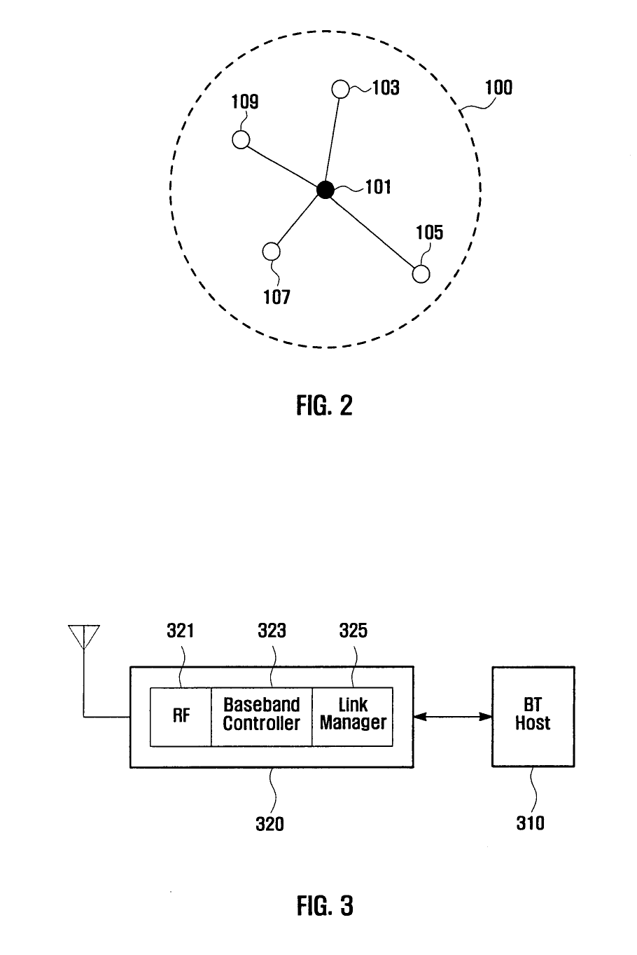

FIG. 2 is a schematic view illustrating an example of a piconet according to the present invention. Referring to FIG. 2, five terminals 101, 103, 105, 107, and 109 constitute a piconet 100 by sharing a common channel. The piconet 100 has a star-shaped topology in which a terminal 101 at the center performs a role of a master terminal and all other devices 103, 105, 107, and 109 operate as slave terminal. At most seven slaves can be active and served simultaneously by the master.

FIG. 3 is a schematic view illustrating a Bluetooth-enabled terminal according to the present invention. As shown in FIG. 3, the terminal includes a Bluetooth Host 310 and a Bluetooth Module 320. The Bluetooth Module 320 can be a Personal Computer Memory Card International Association (PCMCIA) card or a Bluetooth chip and the Bluetooth Host can be a cellular phone, a laptop computer, or a PDA. Typically, the Bluetooth Module 320 is implemented with the integration of an RF part 321, a baseband controller 323, and a link manager 325. A discovery procedure is performed in order to establish links between a master terminal and a slave terminal.

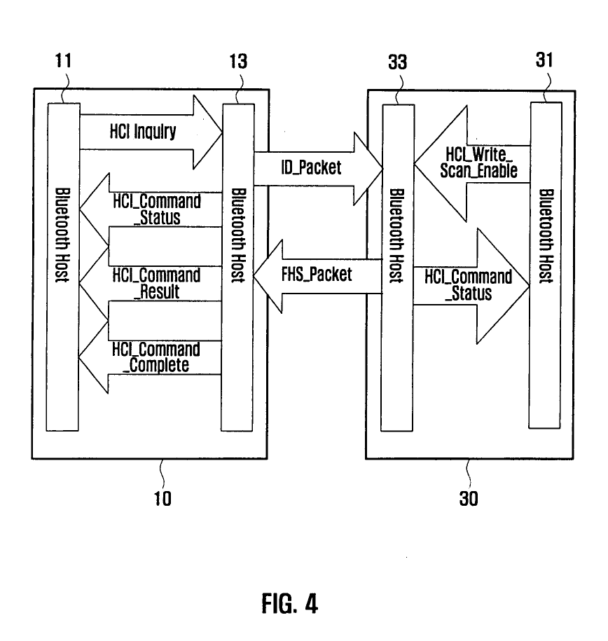

FIG. 4 is a message flow diagram illustrating a discovery procedure for a communication system according to the present invention. Referring to FIG. 4, a master terminal 10 and a slave terminal 30 include a Bluetooth host 11 and 31 respectively and a Bluetooth module 13 and 33 respectively. The master terminal 10 broadcasts an ID packet containing a Device Access Code (DAC), and the slave terminal 30 transmits a Frequency Hopping Synchronization (FHS) packet in response to the ID packet. The FHS packet contains the device address of the slave terminal 30 and timing information required by the master terminal 10 to initiate a connection.

In the master terminal 10, the Bluetooth host 11 transmits an HCI_Inquiry command to the Bluetooth module 13 and the Bluetooth module 13 enters an Inquiry Mode upon receiving the HCI_Inquiry command. When the HCI-Inquiry Command has been started by the Bluetooth module 13, the Bluetooth module 13 transmits an HCI Command Status Event to the Bluetooth host 11. When the inquiry process is completed the Bluetooth module 13 transmits an HCI Inquiry Complete Event to the Bluetooth host 11 indicating that the inquiry has finished. The event parameters of HCI Inquiry Complete have a summary of the result from the Inquiry process, which reports the number of nearby Bluetooth modules that responded. When a Bluetooth terminal responds to the Inquiry message, an HCI Inquiry Result Event occurs to notify the Bluetooth host 11 of the discovery.

In the slave terminal 10, the Bluetooth host 31 transmits HCI_Write_Scan_Enable command to the Bluetooth module 33. Upon receiving the HCI_Write_Scan_Enable message, the Bluetooth module 33 enters a Page Scan mode and periodically scans for page attempts and inquiry requests from other Bluetooth modules. When the Page Scan Mode has been started, the Bluetooth module 33 transmits an HCI_Command_Status event message to the Bluetooth host 31.

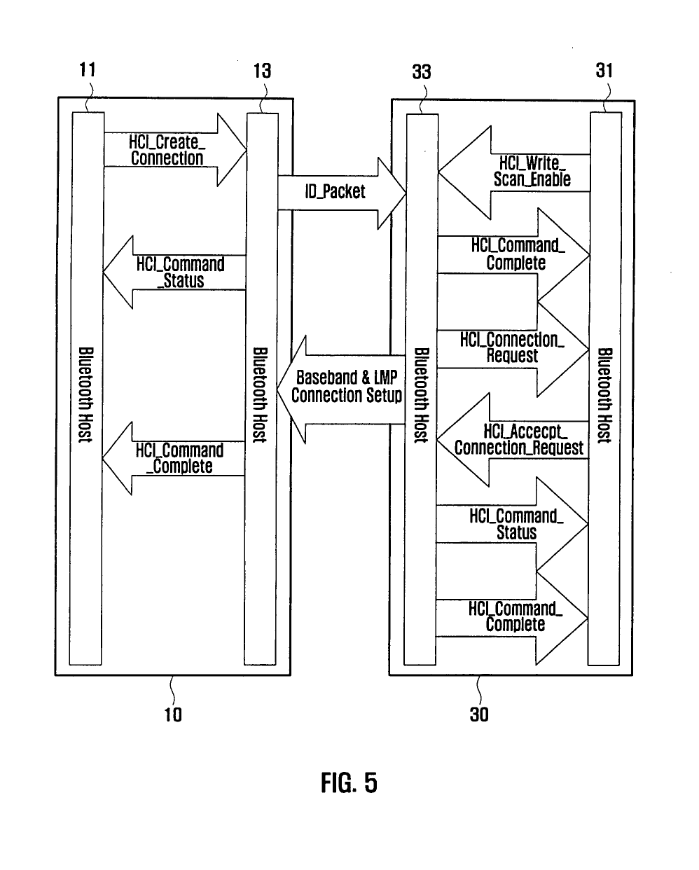

FIG. 5 is a message flow diagram illustrating a connection creation procedure for a communication system according to the present invention.

In the master terminal 10, the Bluetooth host 11 transmits an HCI_Create_Connection command to the Bluetooth module 13. Upon receiving the HCI_Create_Connection message, the Bluetooth module 13 begins a Page process to create a link level connection. The HCI_Create_Connection command contains parameters: BD_ADDR, Packet_Type, Page_Scan_Repetition_Mode, Page_Scan_Mode, and Clock_Offset.

The Bluetooth module 13 determines how a new ACL connection is established. The ACL connection is determined by the current state of the Bluetooth module 13, piconet topology, and the state of the Bluetooth module 33 of the slave terminal 30 to be connected. The Packet_Type command parameter specifies the packet types that the Bluetooth module 13 should use for the ACL connection. The Bluetooth module 13 must use only the packet type specified by the Packet_Type command parameter. Multiple packet types can be specified for the Packet_Type command parameter by performing a bitwise OR operation of the different packet types. The Bluetooth module 13 selects the packet type to be used from the list of acceptable packet types. The Page_Scan_Repetition_Mode and Page_Scan_Mode parameters specify the page scan modes that the Bluetooth module 33 of the slave terminal 30 with the BD_ADR supports. The Clock_Offset parameter is the difference between the clock of the Bluetooth module 13 of the master terminal 10 and the clock of the Bluetooth module 33 of the slave terminal 30.

When the connection creation process has been started, the Bluetooth module 13 transmits an HCI_Command_Status event message to the Bluetooth host 11. When the connection creation process is completed, the Bluetooth module 13 transmits an HCl_Inquiry_Complete message to the Bluetooth host 11 indicating that the connection is established.

In the slave terminal 30, the Bluetooth host 31 transmits an HCI_Write_Scan_Enable command to the Bluetooth module 33. Upon receiving the HCI_Write_Scan_Enable command, the Bluetooth module 33 enters a Page Scan mode and periodically scans for page attempts and inquiry requests from other Bluetooth modules.

If an HCI_Connection_Request event occurs at the Bluetooth module 33, the Bluetooth host 31 transmits an HCI_Accept_Connection_Request command to the Bluetooth module 33 for accepting a new incoming connection request. The HCI_Accept_Connection_Request command causes a Command Status Event to be transmitted from the Bluetooth module 33 when the Bluetooth module 33 begins setting up the connection.

When the Bluetooth modules 13 and 33 determine that the connection is established, the Bluetooth modules 13 and 33 on the master terminal 10 and slave terminal 30 that form the connection transmit an HCI_Connection_Complete event to Bluetooth hosts 11 and 31. When the master terminal establishes a connection with another slave terminal, the previously connected slave terminal enters a sniff mode. The slave terminal in the sniff mode listens to the piconet at regular intervals for short periods.

The slave terminal cannot communicate with another slave terminal except through the master terminal. In this case, HCI ACL Data packet is broadcast to the slave terminals in the sniff mode. A BroadCast (BC) flag of the HCI ACL Data Packet is set to a value of “active broadcast.” For the slave terminal in the sniff mode to transmits data, the slave terminal enters the active mode and then transmits the data to the master terminal, and the master terminal forwards the data to a target slave terminal.

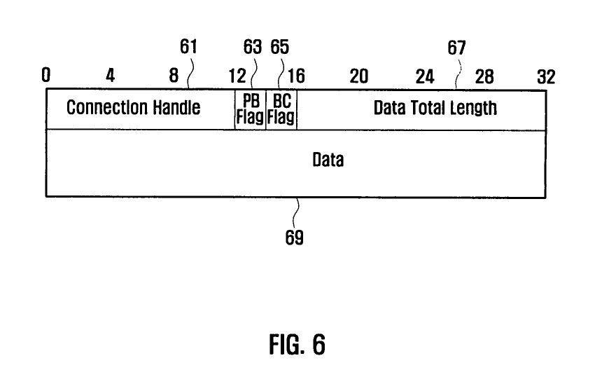

FIG. 6 is a frame format illustrating an HCI ACL Data Packet, which is used to exchange data between the Bluetooth host and the Bluetooth module.

Referring to FIG. 6, the HCI ACL Data packet includes a Connection Handle 61, a Packet Boundary (PB) Flag 63, a Broadcasting (BC) Flag 65, a Data Total Length 67, and Data 69.

The connection handle 61 is a 12-bit identifier, which is used to uniquely address a data/voice connection from one Bluetooth terminal to another. The PB Flag 63 is located in bit 4 and bit 5, and the BC Flag 65 is located in bit 6 and bit 7 in the second byte of the HCI ACL Data Packet.

Table 2 below shows the description of the 2-bit BC Flag 65 of the HCI ACL Data packet from the Bluetooth host to the Bluetooth module.

TABLE 2

| Value | Parameter Description |
|---|---|
| 00 | No broadcast. Only point-to-point. |
| 01 | Active Slave Broadcast: packet is transmitted to all active |
| | slaves (i.e. packet is usually not transmitted during park |
| | beacon slots), and can be received by slaves in sniff |
| | mode or park state. |
| 10 | Parked Slave Broadcast: packet is transmitted to all |
| | slaves including slaves in park state (i.e. packet is |
| | transmitted during park beacon slots if there are parked |
| | slaves), and it may be received by slaves in sniff mode. |
| 11 | Reserved for future use. |

Table 3 below shows the description of the 2-bit BC flag 65 of the HCI ACL Data Packet from the Bluetooth module to the Bluetooth host.

TABLE 3

| Value | Parameter Description |
|---|---|
| 00 | Point-to-point |
| 01 | Packet received as a slave not in park state (either Active |
| | Slave Broadcast or Parked Slave Broadcast) |
| 10 | Packet received as a slave in park state (Parked Slave |
| | Broadcast) |
| 11 | Reserved for future use |

After a piconet is formed, the terminals participate in a chat through ACL links.

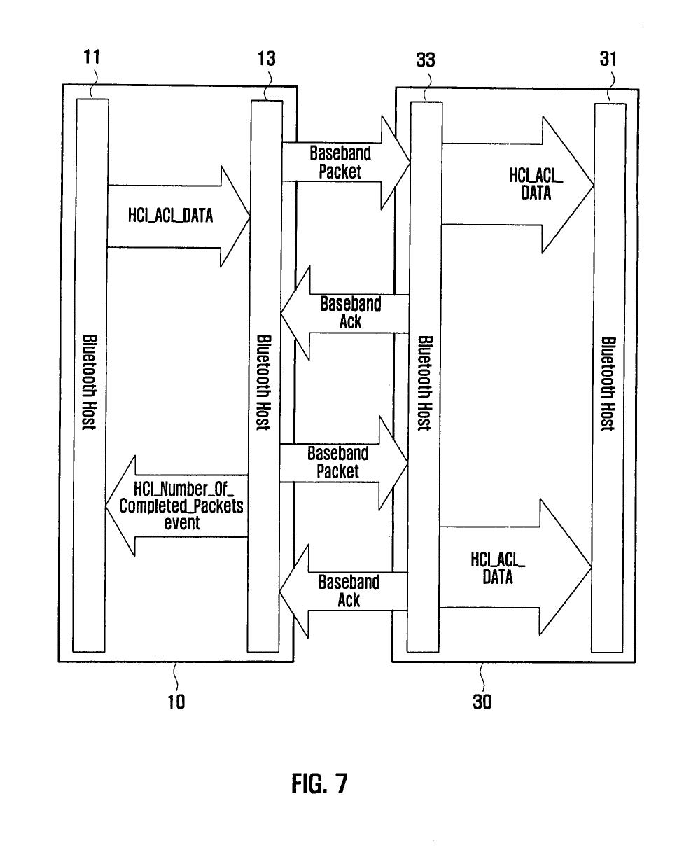

FIG. 7 is a message flow diagram illustrating a chatting procedure for a communication system according to the present invention.

In the master terminal 10, the Bluetooth host 11 transmits an HCI_ACL_DATA packet to the Bluetooth module 13. If the HCI_ACL_DATA Packet is received, the Bluetooth module 13 breaks the HCI_ACL_DATA Packet into Baseband Packets.

If a transmission buffer of a Bluetooth module 13 is filled up, the Bluetooth module 13 transmits an HCI_Number_Of_Completed_Packets event to the Bluetooth host 11.

The baseband packets are transmitted to the slave terminal 30 and are combined into the HCI_ACL_DATA Packet by the Bluetooth module 33 of the slave terminal 30. The Bluetooth module 33 transfers the HCI_ACL_DATA Packet to the Bluetooth host 31. The slave terminal 30 transmits data to the master terminal 10 in the same manner.

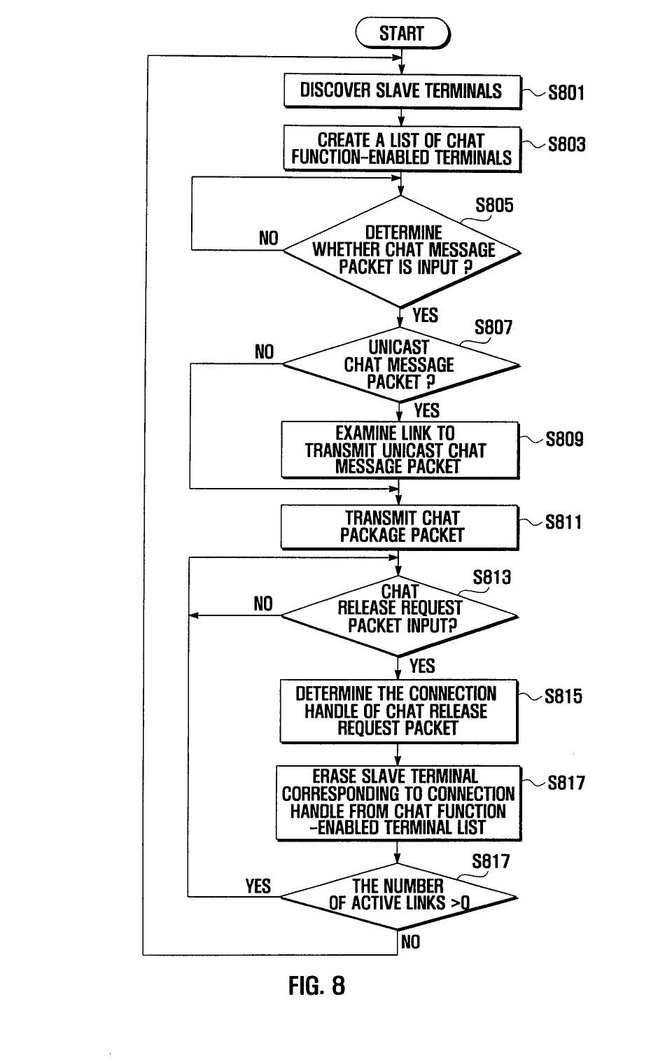

FIG. 8 is a flowchart illustrating a chatting method over Bluetooth according to the present invention.

Referring to FIG. 8, in step S801 a master terminal discovers slave terminals and then, in step S803, creates a list of chat function-enabled terminals. After creating the chat function-enabled terminal list, in step S805 the master terminal determines whether a chat message packet is input. If a chat message packet is input, in step S807 the master terminal determines whether the chat message packet is a unicast chat message packet. If the chat message packet is a unicast chat message packet, the master terminal examines a link to transmit the unicast chat message packet in step S809 and then in then in step S811 transmits the unicast chat message packet through the link.

If the chat message packet is not a unicast chat message packet, in step 811 the master terminal determines that the chat message packet is a broadcast chat message packet so as to transmit the broadcast chat message packet.

The master terminal determines the type of the chat message packet by checking the broadcast flag of the packet. That is, if the value of the broadcast flag is 00, the chat message packet is a unicast chat message packet. If the value of the broadcast flag is 01 or 10, the chat message packet is a broadcast chat message packet.

The link to transmit the unicast chat message packet is determined by checking the connection handle of the unicast chat message packet, which is a unique link identifier.

If the chat message packet is a broadcast chat message packet, the master terminal transmits the broadcast chat message packet to all slave terminals in the chat function-enabled terminal list in step S811.

The chat message packet can be generated in the master terminal or by a chat message packet received from another slave terminal. The slave terminals cannot directly exchange the chat message packet with each other, but via the master terminal. Accordingly, a slave terminal that wants to broadcast a chat message, transmits the chat message to the master terminal, and the master terminal then broadcasts the chat message.

During communication between the master terminal and the respective slave terminals in step S813, the master terminal determines whether a chat release request packet is input. In step S815 if a chat release request signal is input, the master terminal determines the connection handle of the chat release request packet, and then in step S817 erases the slave terminal corresponding to the connection handle from the chat function-enabled terminal list.

If a slave terminal wants to terminate a connection to the master terminal or to another slave terminal, the slave terminal is only required to release the connection to the master terminal.

If the master terminal is turned off, all the connections to the slave terminals are released.

After erasing the slave terminal that transmitted the chat release request, the master terminal determines whether the number of active links connected to the slave terminals in the chat function-enabled terminal list is greater than 0 in step S819. If the number of the slave terminals is greater than 0, the master terminal repeats step S813. If the number of the slave terminals is 0, the master terminal ends the chatting process.

As described above, the communication system and method for portable terminals according to the present invention enable the portable terminals to exchange messages in the unlicensed 2.4 GHz Industrial Scientific Medical (ISM) frequency band without engagement of a fixed base station, whereby it is possible for the portable terminals to communicate even outside a main communication system coverage.

The communication system and method for portable terminals according to the present invention provide at least one asynchronous connectionless link and one synchronous connection-oriented link between a master terminal and at least one slave terminal, whereby each portable terminal can participate in a chat with at least one other portable terminal over respective asynchronous connectionless links and simultaneously communicate with one other portable terminal over the Synchronous Connection-Oriented link.

Also, the communication system and method for portable terminals according to the present invention provide a cellular communication interface and a short range communication interface, whereby each portable terminal can participate in a chat with at least one other portable terminal over respective device-to-device asynchronous connectionless links and communicate with one other portable terminal over a device-to-device synchronous connection-oriented link and another portable terminal over a fixed station-engaged cellular communication link.

Although exemplary embodiments of the present invention have been described in detail hereinabove, it should be understood that many variations and modifications of the basic inventive concepts herein taught which may appear to those skilled in the present art will still fall within the spirit and scope of the present invention, as defined by the appended claims.

What is claimed is:

1. A communication method for a short range wireless communication system including at least two terminals directly connected to each other, comprising:
generating, at a first terminal, a list of second terminals supporting a chat function;
establishing at least one asynchronous connectionless link between the first terminal and at least one second terminal; and
exchanging chat packets through the asynchronous connectionless link between the first and second terminals.

2. The communication method of claim 1, wherein exchanging chat packets comprises:
determining, at the first terminal, whether the chat packet to be transmitted is a unicast chat packet before transmitting the chat packet from the first terminal to the second terminal;
checking a link identifier of the asynchronous connectionless link if the chat packet is a unicast chat packet;
transmitting the chat packet through the asynchronous connectionless link having the link identifier; and
transmitting the chat packet through all asynchronous connectionless links if the chat packet is not a unicast chat packet.

3. The communication method of claim 2, wherein exchanging chat packets further comprises:
determining, at the first terminal, whether a chat packet received from the second terminal is a unicast chat packet; and
transmitting the chat packet through all asynchronous connectionless links except for the link through which the chat packet is received if the chat packet is not a unicast chat packet.

4. The communication method of claim 1, further comprising:
establishing a synchronous connection oriented link between the first terminal and a selected second terminal.

5. The communication method of claim 4, further comprising:
exchanging voice packets through the synchronous connection oriented link between the first and the selected second terminal.

6. A communication method for a Bluetooth®-based piconet including a master terminal and at least one slave terminal, comprising:
discovering, at the master terminal, slave terminals;
checking slave terminals enabling a chat function among the discovered slave terminals;
generating a list of slave terminals enabling a chat function;
establishing at least one asynchronous connectionless link between the master terminal and at least one chat function-enabled slave terminal; and
exchanging chat packets through the asynchronous connectionless link between the master and the chat function-enabled slave terminals.

7. The communication method of claim 6, wherein discovering slave terminals comprises:
transmitting an identity (ID) packet;
receiving Frequency Hopping Synchronization (FHS) packets from the slave terminals in response to the ID packet; and
synchronizing a frequency hopping pattern on a basis of the FHS packet.

8. The communication method of claim 6, wherein exchanging chat packets comprises:
determining, at the master terminal, whether the chat packet to be transmitted is a unicast chat packet before the master terminal transmits the chat packet;
checking a link identifier of the asynchronous connectionless link if the chat packet is a unicast chat packet;
transmitting the chat packet through the asynchronous connectionless link having the link identifier; and
transmitting the chat packet through all asynchronous connectionless links if the chat packet is not a unicast chat packet.

9. The communication method of claim 8, wherein exchanging chat packets further comprises:
determining, at the master terminal, whether a chat packet received from the slave terminal is a unicast chat packet; and
transmitting the chat packet through all asynchronous connectionless links except for the link through which the chat packet is received if the chat packet is not a unicast chat packet.

10. The communication method of claim 6, further comprising:
establishing a synchronous connection oriented link between the master terminal and another slave terminal.

11. The communication method of claim 6, wherein the chat packet is a voice packet.

12. The communication method of claim 11, wherein the voice packet is transmitted in a push-to-talk manner.

13. A communication method for a wireless communication system including at least one fixed station serving a plurality of mobile terminals each having a fixed station-engaged communication interface and a terminal-to-terminal communication interface, comprising:
establishing at least one terminal-to-terminal asynchronous connectionless link between a first mobile terminal and at least one second mobile terminal;
establishing a terminal-to-terminal synchronous connection oriented link between the first mobile terminal and another second mobile terminal; and
establishing a fixed station-engaged communication link between the first mobile terminal and still other communication terminal.

14. The communication method of claim 13, further comprising: exchanging chat packets through the asynchronous connectionless link between the first mobile terminal and the second mobile terminal in a push-to-talk manner.

15. The communication method of claim 14, wherein the chat packet is a voice packet.
